(19) United States
(12) Patent Application Publication
(10) Pub. No.: US 2015/0360136 A1
(43) Pub. Date: Dec. 17, 2015

(54) Controller with Movable Steering Wheel

(71) Applicant: Playmind Limited, TST East (HK)

(72) Inventor: Gauss King Shung Choi, Tai Po (HK)

(73) Assignee: Playmind Limited, TST East (HK)

(21) Appl. No.: 14/306,618

(22) Filed: Jun. 17, 2014

(51) Int. Cl. A63H 30/04; G05G 1/10

(52) U.S. Cl. CPC A63H 30/04; G05G 1/10

(57) ABSTRACT

A controller for a remote-control toy has a handle portion and a barrel portion, the barrel portion defining a longitudinal axis. A drum is positioned in a first fixed position at a section of the barrel portion, the drum having a control wheel that is positioned along a first side of the barrel portion. The drum can be unlocked from the fixed position by a locking mechanism, and the drum can be rotated about the longitudinal axis so that the wheel is positioned along a second side of the barrel portion. The drum can then be locked in a second fixed position with respect to the barrel portion.

### BACKGROUND OF THE INVENTION

1. Field of the Invention

The present invention relates to remote controllers, and in particular, to a remote controller that is shaped like a gun and having a steering wheel on one side that can be moved to the other side to accommodate users who use the other hand.

2. Description of the Prior Art

Remote control toys have become very popular. A radio-controlled toy, such as a radio-controlled car, is generally operated by a transmitter, or controller, which transmits radio signals to the radio-controlled car. Such controllers are typically configured for one of either left-handed or right-handed use. Thus, separate controllers are required for left-handed and right-handed users. This may be both inconvenient and expensive, as additional effort is expended by manufacturers to provide the separate controllers, and users may need to purchase additional controllers to ensure that anyone desiring to use their radio-controlled car may do so.

Attempts have been made to provide controllers that allow for adjustability between left-handed and right-handed use. However, these controllers suffer from a number of drawbacks. Most significantly, these controllers have a complex construction which renders them difficult to use and expensive to produce.

Therefore, there remains a need for a controller that is adjustable for left-handed or right-handed use, yet is relatively simple in accommodating such adjustment.

### SUMMARY OF THE DISCLOSURE

In order to accomplish the objects of the present invention, the present invention provides a controller for a remote-control toy. The controller has a handle portion and a barrel portion, the barrel portion defining a longitudinal axis. A drum is positioned in a first fixed position at a section of the barrel portion, the drum having a control wheel that is positioned along a first side of the barrel portion. The drum can be unlocked from the fixed position by a locking mechanism, and the drum can be rotated about the longitudinal axis so that the wheel is positioned along a second side of the barrel portion. The drum can then be locked in a second fixed position with respect to the barrel portion.

The drum can be locked via a locking mechanism that secures the drum at a fixed position with respect to the barrel portion. An actuator is coupled to the locking mechanism for locking and unlocking the drum for rotation.

### BRIEF DESCRIPTION OF THE DRAWINGS

FIG. 1A is a perspective view of a controller according to the present invention with the control wheel on the right-handed side.

FIG. 1B is a perspective view of the controller of FIG. 1A shown with the right housing removed, and with the wheel drum in the locked position.

FIG. 2 is a perspective view of the controller of FIG. 1A shown with the right housing removed, and with the wheel drum in the unlocked position.

FIG. 3 is a perspective view of the controller of FIG. 1A shown with the right housing removed, and with the wheel drum rotated by ninety degrees.

FIG. 4 is a perspective view of the controller of FIG. 1A shown with the right housing removed, and with the wheel drum rotated by one hundred and eight degrees so that the control wheel is on the left-handed side.

FIG. 5 is a cross-sectional view of the controller of FIG. 1A shown with the left housing removed, and with the wheel drum in the locked position.

FIG. 6 is a cross-sectional view of the controller of FIG. 1A shown with the left housing removed, and with the wheel drum in the unlocked position.

### DETAILED DESCRIPTION OF THE PREFERRED EMBODIMENTS

The following detailed description is of the best presently contemplated modes of carrying out the invention. This description is not to be taken in a limiting sense, but is made merely for the purpose of illustrating general principles of embodiments of the invention. The scope of the invention is best defined by the appended claims.

The present invention provides a controller 10 that is configured as a gun. The controller 10 includes a control wheel 12 that can be used for remotely controlling a toy object, such as a vehicle or animal. The controller 12 is configured so that the control wheel 12 can be conveniently and quickly moved from one side of the gun to the other side of the gun to facilitate use by left-handed and right-handed users.

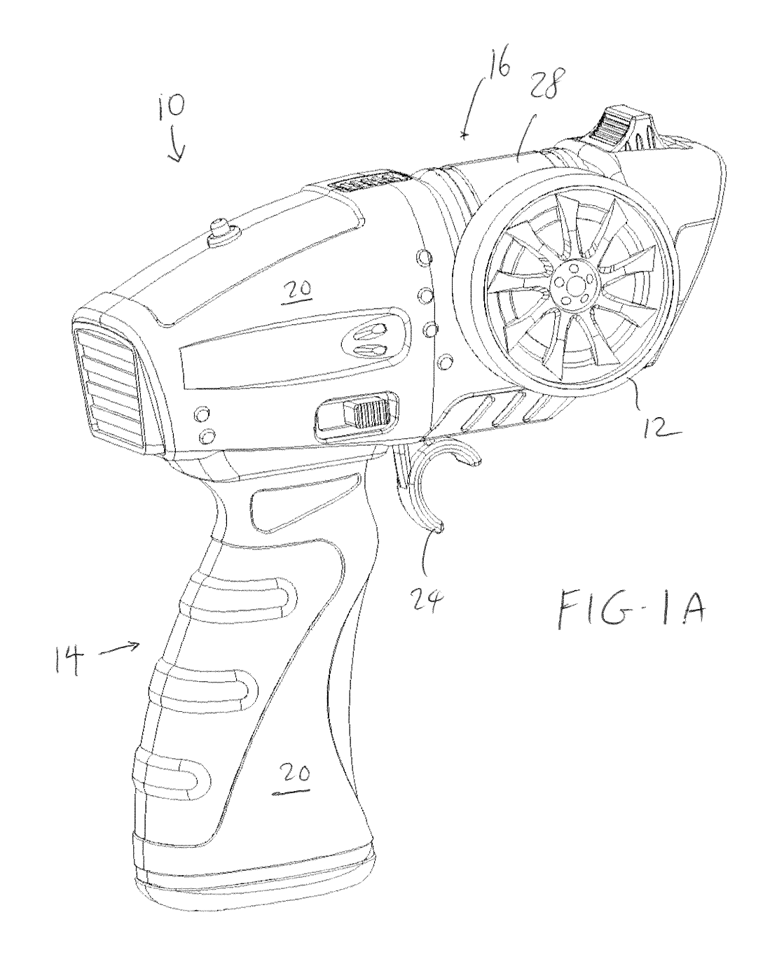

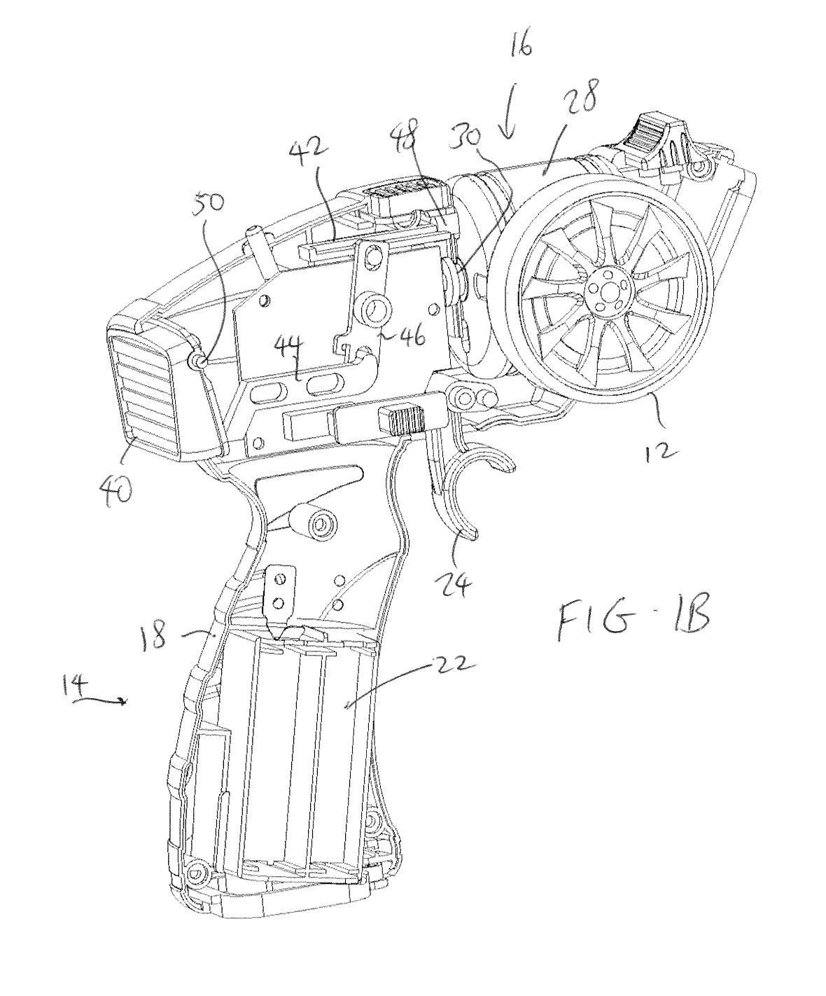

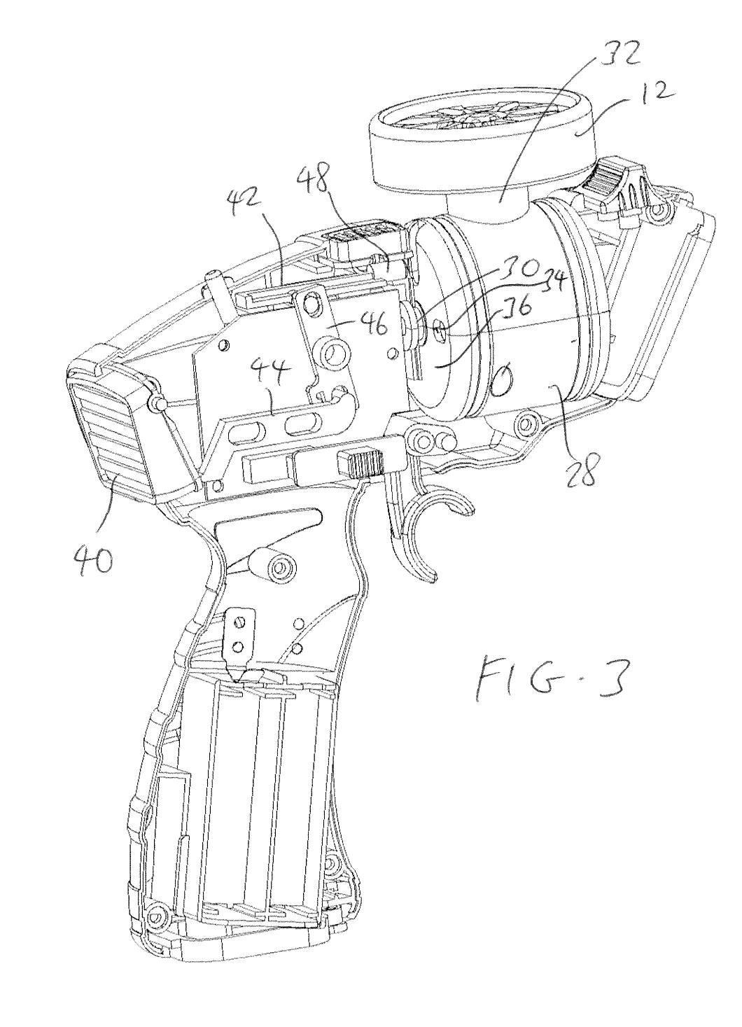

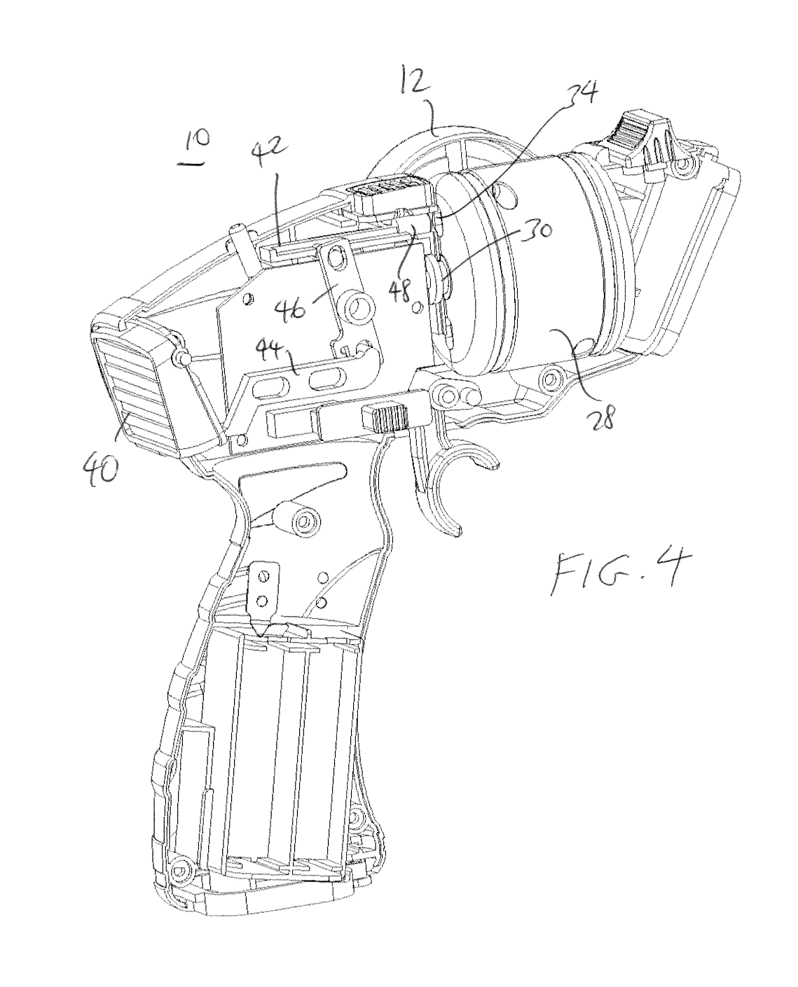

Referring to FIGS. 1-6, the controller 10 is configured as a gun with a handle portion 14 and a barrel portion 16. A rotatable control wheel 12 is positioned on the right side of the barrel portion 16 for use by a right-handed user, and can be moved to the left side of the barrel portion 16 (see FIGS. 3 and 4) for use by a left-handed user.

The barrel portion 16 and the handle portion 14 are defined by a left housing shell 18 and a right housing shell 20. Batteries (not shown) can be housed in a battery housing 22 that is located in the handle portion 14. An optional trigger 24 can extend from below the barrel portion 16 adjacent the handle portion 14, and is used by the user to actuate an operation (e.g., firing a signal or light ray, etc.). The trigger 24 can be mechanically and/or electrically coupled to the batteries and other actuating mechanisms using connectors or couplings that are well-known in the art.

The barrel portion 16 has a section 26 that has been cut-out along the shells 18 and 20 from the top thereof. A drum 28 is received in this cut-out section 26. The drum 28 is somewhat cylindrical in configuration and has the wheel 12 operationally secured to its outer side wall via a stem 32 (see FIG. 3). As best seen in FIGS. 1B and 5-6, a shaft 30 extends longitudinally through the central longitudinal axis of the drum 28, and the shaft 30 has opposite ends secured for rotation in the barrel portion 16 so that the drum 28 can be rotated about the axis defined by the shaft 30. A plurality of openings 34 (e.g., two openings, one opening for each of the two positions to be assumed by the wheel 12) are also positioned on the inner wall 36 of the drum 28 that faces the rear of the barrel portion 16.

A locking system is provided in the barrel portion 16. The locking system includes a push button 40 that is provided at the rear of the barrel portion 16, a locking pin 48 that is adapted to be inserted through one of the openings 34 to secure the drum 28 in a fixed position, and a linkage system that couples the push button 40 to the locking pin 48. The linkage system includes a first link member 44 having a first end that is pivotally coupled to the push button 40 and a second end that is pivotally coupled to a first end of a second link member 46. The opposite second end of the second link member 46 is pivotally coupled to a first end of a third link member 42, whose opposite second end carries the locking pin 48. The center of the second link member 46 is pivotally connected to the shells 18, 20 by a pivot shaft 54. A spring 56 has one end secured to a post 58 and an opposite end secured to a hook member 60 that is located near the first end of the second link member 46. The push button 40 is pivotally connected at its upper end via a pivot pin 50 to the shells 18 and 20.

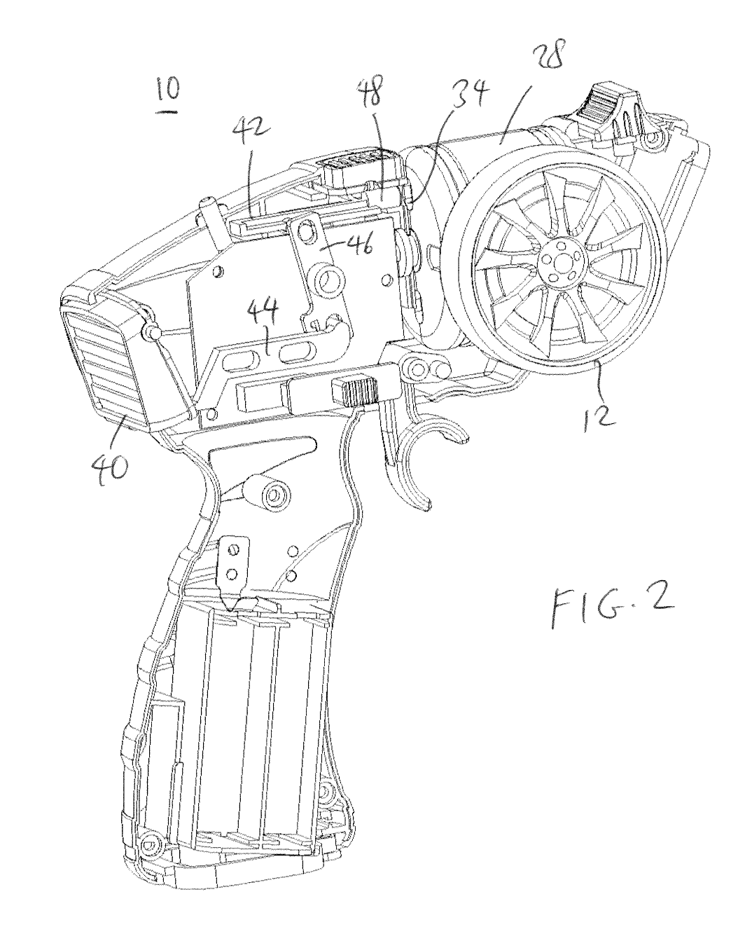

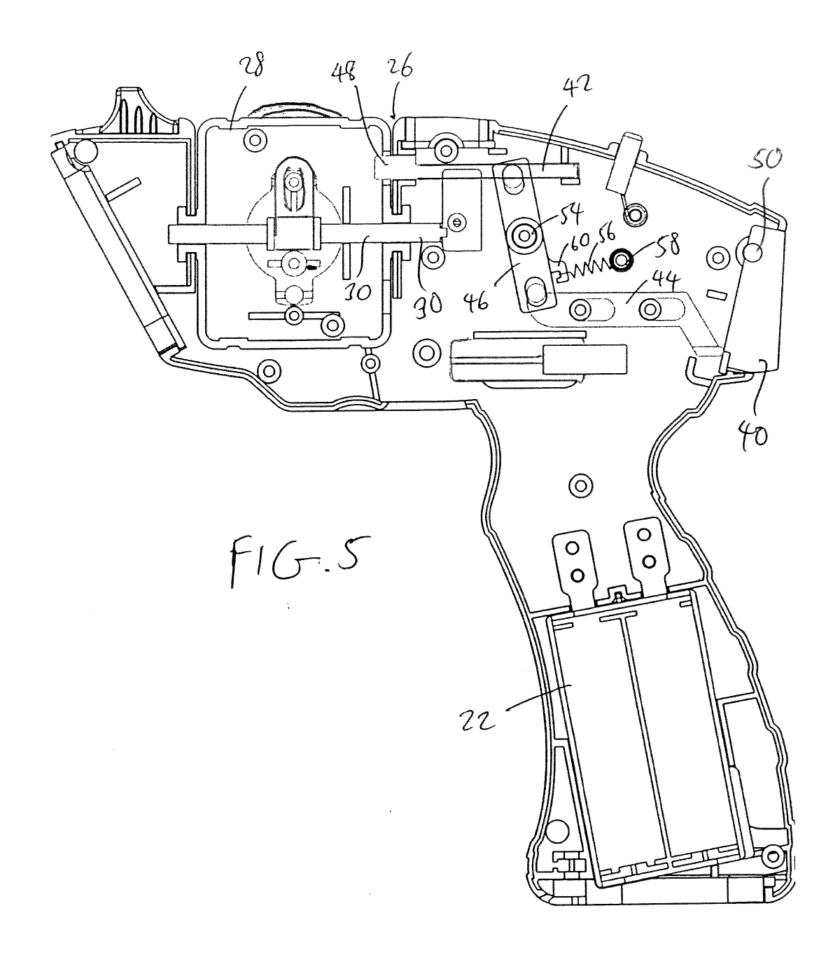

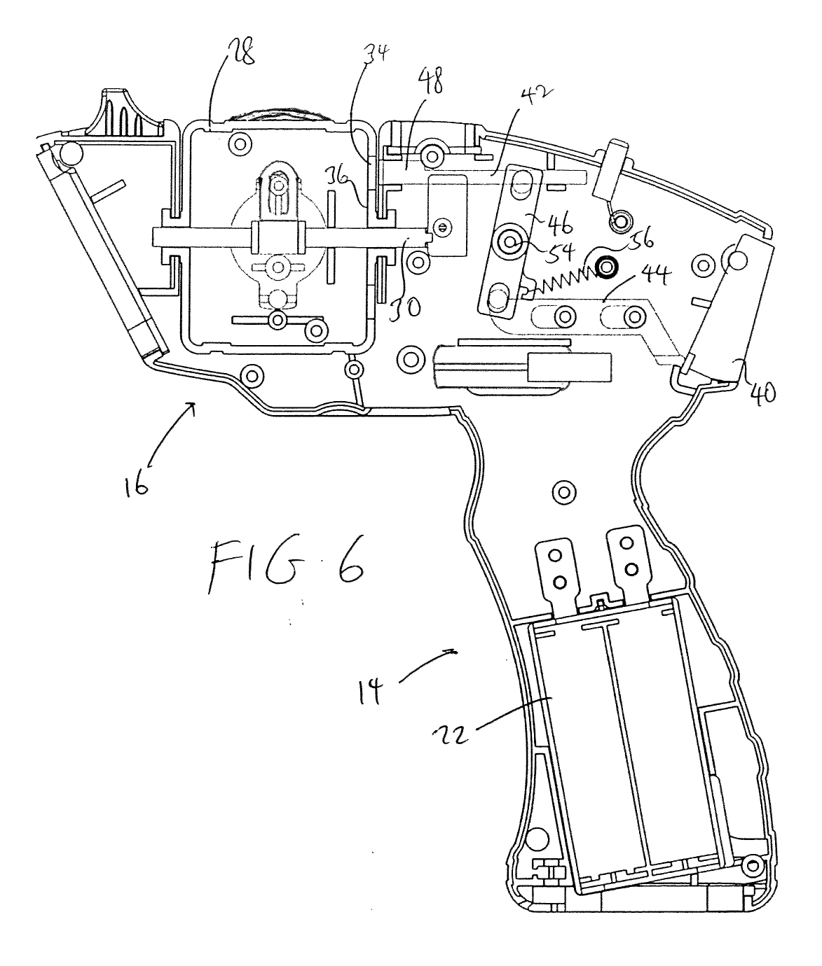

FIGS. 1A, 1B and 5 illustrate the controller 10 in normal use, when the drum 28 is secured at a fixed position by the locking pin 48 seated in an opening 34. When the user desires to rotate the drum 28 from the right-handed side to the left-handed side, the user presses the push button 40 at its bottom end (see FIGS. 2 and 6), causing the first link member 44 to be pushed forward. This in turn pushes the first end of the second link member 46 forward, so that the second link member 46 pivots about the pivot shaft 54 and the second end of the second link member 46 is pulled rearwardly. This rearward movement of the second end of the second link member 46 pulls the third link member 42 rearwardly, causing the locking pin 48 to retract from the opening 34. At this point, the drum 28 is free to rotate, and the user can rotate the drum 28 towards the left-handed side (while still pressing on to the push button 40). FIG. 3 shows the drum 28 half-way through the rotation and FIG. 4 shows the drum 28 rotated to the left-handed side. At this time, the user can release his/her hold on the push button 40, and then the normal bias of the spring 56 will pull the first end of the second link member 46 towards the rear of the barrel portion 16. See FIG. 5. This will cause the second link member 46 to pivot about the pivot shaft 54, pushing the third link member 42 forward so that the locking pin 48 will be inserted into another opening 34 to secure the drum 28 in the left-handed position. To move the wheel 12 to the right-handed position, the user simply repeats the steps described above.

The wheel 12 can be mechanically and/or electrically coupled to the batteries and other processing circuits and mechanisms using connectors or couplings that are well-known in the art, so that the wheel 12 can be used to control the toy or object that the controller 10 is used with.

Thus, the present invention provides a simple and convenient system for moving a control wheel 12 between the left-handed and right-handed positions. The wheel 12 is carried on a drum 28 that can be rotated between the two positions, and secured at either position by a locking pin 48 that can be retracted via a linkage system by pushing a push button 40.

While the description above refers to particular embodiments of the present invention, it will be understood that many modifications may be made without departing from the spirit thereof. The accompanying claims are intended to cover such modifications as would fall within the true scope and spirit of the present invention.

What is claimed is:

1. A controller for use with a remote-control toy, comprising:
a body having a handle portion and a barrel portion, the barrel portion defining a longitudinal axis;
a drum positioned in a section of the barrel portion, the drum being rotatable about the longitudinal axis to occupy a plurality of positions with respect to the barrel portion;
a control wheel carried on the drum and positioned along a side of the barrel portion;
a locking mechanism that secures the drum at a fixed position with respect to the barrel portion; and
an actuator that is coupled to the locking mechanism for locking and unlocking the drum for rotation.

2. The controller of claim 1, wherein the locking mechanism is a locking pin, and further including:
a linkage system that couples the actuator to the locking mechanism, the linkage system having a plurality of link members that mechanically connect the actuator to the locking pin;
wherein the drum includes a plurality of openings for receiving the locking pin, with each opening receiving the locking pin at a separate location occupied by the drum with respect to the barrel portion.

3. A method of using a controller for a remote-control toy, comprising the steps of:
providing a controller having a body having a handle portion and a barrel portion, the barrel portion defining a longitudinal axis;
positioning a drum in a first fixed position at a section of the barrel portion, the drum having a control wheel that is positioned along a first side of the barrel portion;
unlocking the drum from the fixed position;
rotating the drum about the longitudinal axis so that the wheel is positioned along a second side of the barrel portion; and
locking the drum in a second fixed position with respect to the barrel portion.

4. The method of claim 3, wherein the step of unlocking the drum includes activating an actuator to release a lock mechanism from the drum.

5. The method of claim 4, wherein the step of locking the drum includes activating an actuator to cause a lock mechanism to engage a portion of the drum.

6. The method of claim 5, wherein the controller includes a linkage system that couples an actuator to a locking mechanism, the linkage system having a plurality of link members that mechanically connect the actuator to the lock mechanism, and wherein the drum includes a plurality of openings for receiving the locking mechanism, further including:
wherein the step of unlocking includes removing the locking mechanism from one of the openings.
